(19) United States
(12) Patent Application Publication
(10) Pub. No.: US 2009/0293858 A1
(43) Pub. Date: Dec. 3, 2009

(54) GRILL APPARATUS

(76) Inventor: CHARLES Z. KRASZNAI, Bridgeport, CT (US)

Correspondence Address: Lawrence Cruz;Conair Corporation, One Cummings Point Road, STAMFORD, CT, 06902, US

(21) Appl. No.: 12/130,393

(22) Filed: May 30, 2008

(51) Int. Cl. A47J 37/00

(52) U.S. Cl. 126/25 R

(57) ABSTRACT

A grill apparatus (10) includes a base (12), first and second grills (16, 18) supported by the base (12) with each grill (16, 18) having a grilling surface (16a, 16b) for cooking a food product, and first and second control members (26a, 26b) for independently and selectively controlling the temperature of the grilling surfaces (16a, 16b) of the first and second grills 16, 18) respectively. First and second heating elements (24a, 24b) may be supported by the base (12) and in communication with the first and second grills (16, 18) respectively. The first and second heating elements (24a, 24b) are controlled the first and second control members (24a, 24b) respectively. A release mechanism for releasably securing at least one of the first and second grills (16, 18) to the base (12) may be provided. The release mechanism may include a release member (22) having a latch (34) releasably engageable with the one of the first and second grills (16, 18). The release member (22) is movable from a locked position whereby the latch (34) engages the one of the first and second grills (16, 18) and a release position whereby the latch (34) releases the one of the first and second grills (16, 18) to permit removal from the base (12). The release member (22) may be normally biased toward the locked position. In one embodiment, first and second release mechanisms for releasably securing the first and second grills (16, 18) respectively to the base (12) are provided.

### BACKGROUND

The present disclosure generally relates to cooking appliances and, in particular, relates to a grill apparatus having a pair of grilling plates with individual temperature controls and a latch mechanism for releasably securing the grilling plates to the grill base.

Grills, and in particular electric grills, are known. These devices are generally constructed with heating plates having a particular surface geometry for heating food placed thereon. The heating plates may be secured to a housing and heated by an electrical resistance heater. An example of a grill apparatus is disclosed in commonly assigned U.S. Pat. No. 7,109,442 to Steinberg.

### SUMMARY

Accordingly, the present disclosure is directed to further improvements in grill apparatuses. In one embodiment of the present disclosure, the grill apparatus includes a base, first and second grills supported by the base with each grill having a grilling surface for cooking a food product, and first and second control members for independently and selectively controlling the temperature of the grilling surfaces of the first and second grills respectively. First and second heating elements may be supported by the base and in communication with the first and second grills respectively. The first and second heating elements are controlled the first and second control members respectively. A release mechanism for releasably securing at least one of the first and second grills to the base may be provided. The release mechanism may include a release member having a latch releasably engageable with the one of the first and second grills. The release member is movable from a locked position whereby the latch engages the one of the first and second grills and a release position whereby the latch releases the one of the first and second grills to permit removal from the base. The release member may be normally biased toward the locked position. In one embodiment, first and second release mechanisms for releasably securing the first and second grills respectively to the base are provided.

The release member may be slideably movable relative to the base to move between the locked position and the release position. In the alternative, the release member may be adapted to pivot relative to the base between the locked position and the release position. One of the first and second grills may be normally biased in a direction away from the base whereby, upon release of the latch of the release member during movement thereof to the release position, the one of the first and second grills is displaced from the base to thereby facilitate removal therefrom. The base may house a biasing spring. The biasing spring engages and biases the one of the first and second grills away from the base.

Other embodiments are also envisioned.

### BRIEF DESCRIPTION OF THE DRAWINGS

The accompanying drawings, which are incorporated in and constitute a part of this specification, illustrate embodiments of the disclosure and, together with a general description of the disclosure given above, and the detailed description of the embodiment(s) given below, serve to explain the principles of the disclosure, wherein

FIGS. 1-2 are frontal and rear perspective views, respectively, of a grill apparatus in accordance with the principles of the present disclosure illustrating the base, grill plates supported within the base and the control knobs;

FIG. 3 is a top plan view of the grill apparatus;

FIGS. 4-5 are front and side plan views, respectively, of the grill apparatus;

FIG. 6 is a cross-sectional view of the grill apparatus taken along the lines 6-6 of FIG. 4;

FIG. 7A is an enlarged view of the area of detail depicted in FIG. 6 illustrating the release mechanism for releasably securing the grill plates to the base, and in a locked position;

FIG. 7B is a view similar to the view of FIG. 7A illustrating the release mechanism in an unlocked position;

FIG. 8 is a top plan view of the grill apparatus illustrating the grill plates removed;

FIGS. 9-10 are top and frontal plan views of an alternate embodiment of the grill apparatus of FIG. 1; and

FIGS. 11A-11B are views illustrating the release mechanism for releasably securing the grill plates of the grill apparatus of FIGS. 9-10.

### DETAILED DESCRIPTION

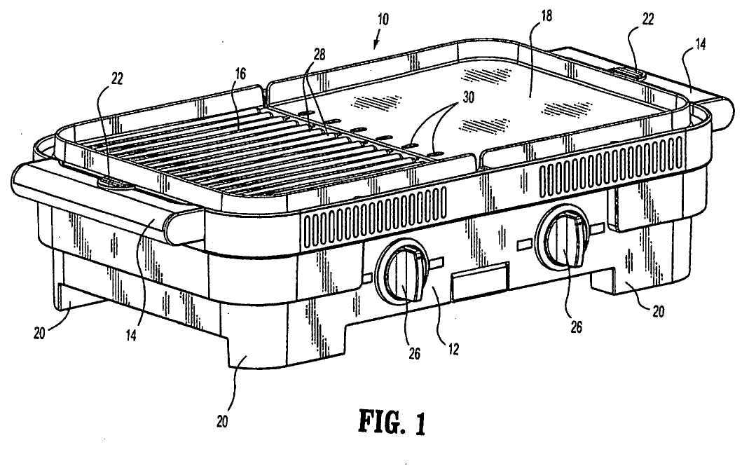

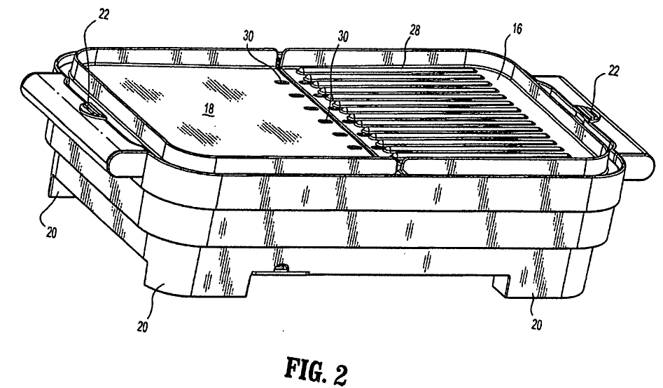

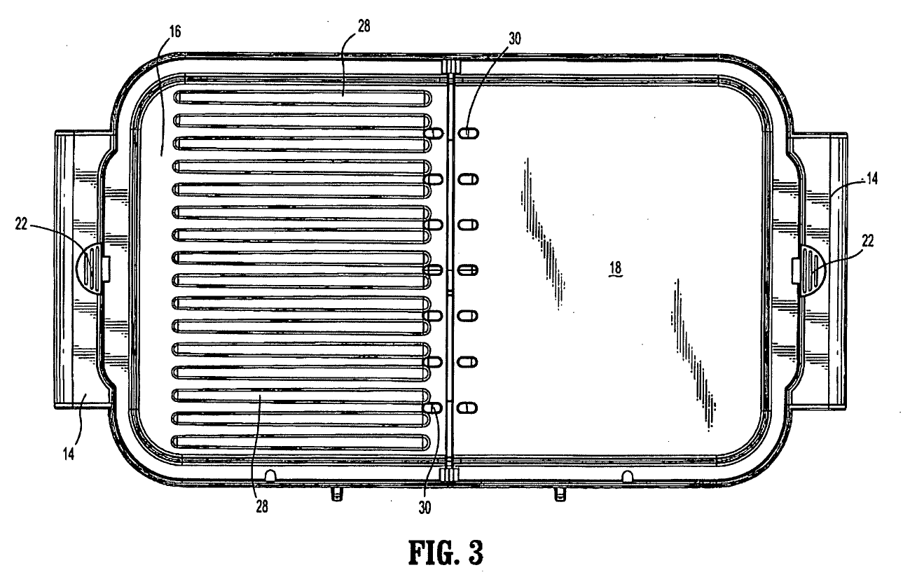

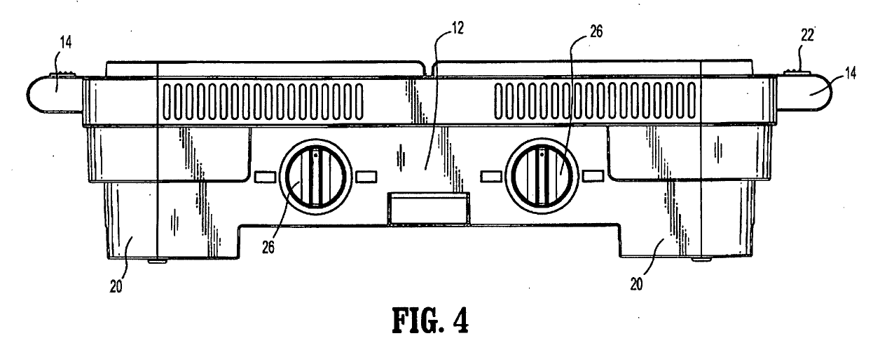

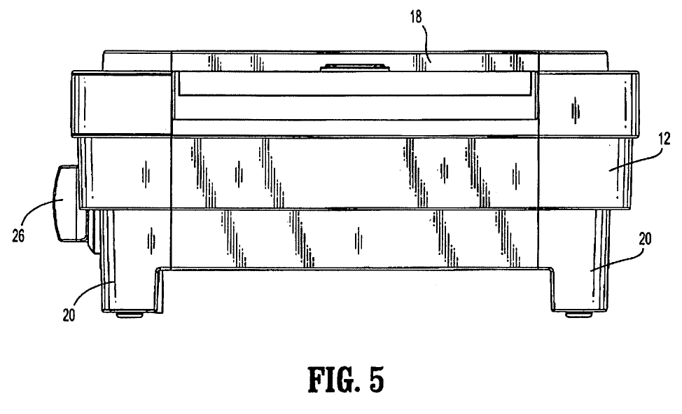

Referring now to the drawings wherein like references identical or similar elements throughout the several views, FIGS. 1-8 illustrate an embodiment of the cooking apparatus in accordance with the principles of the present disclosure. Cooking apparatus 10 is preferably a portable unit adapted for positioning on a support surface such as a table, countertop or the like. Cooking apparatus 10 includes base 12 having handles 14 extending from opposed sides of the base 12, and first and second grills 16, 18 supported by the base 12. Base 12 may incorporate four legs 20 at each corner to elevate base 12 from the support surface. Handles 14 preferably include release members 22 adapted to releasably secure first and second grills 16, 18 to base 12. Release members 22 will be described in greater detail hereinbelow.

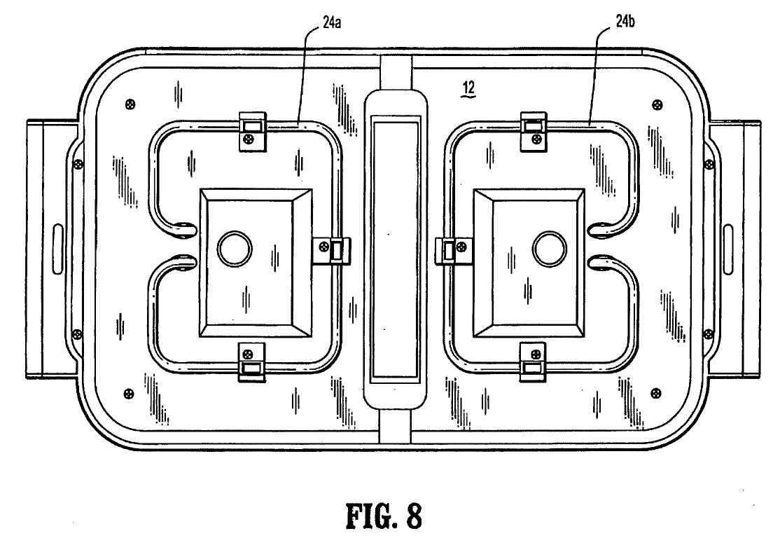

First and second grills 16, 18 are nested within base 12. In one embodiment, first and second grills 16, 18 reside on internal ledges of base 12. Each grill 16, 18 is in electrical communication with a separate heater or coil 24a, 24b (FIG. 8) disposed beneath the respective grill 16, 18. Heater or coils 24a, 24b are preferably resistive heating elements known in the art. Heaters 24a, 24b are controlled by separate temperature controls or dials 26 mounted to the front face of base 12. Thus, heaters 24a, 24b are separately and individually controlled via dials 26a, 26b to individually heat first and second grills 16, 18 to desired cooking or grilling temperatures. Accordingly, different food products may be cooked simultaneously on first and second grills 16, 18 thereby increasing the versatility and usability of cooking apparatus 10.

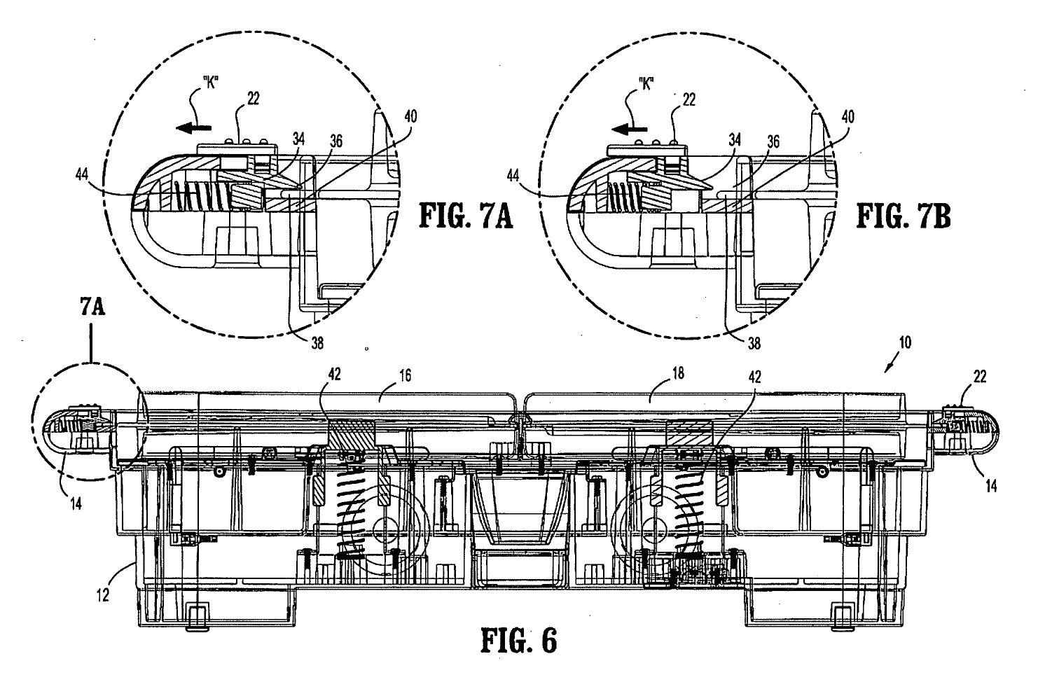

First grill 16 may include a grilling surface 16a defining a ribbed contour incorporating a plurality of ribs 28 to elevate the food product cooked on the first grill 16. Ribs 28 are illustrated as parallel and of constant length; however, other designs are contemplated. Second grill 18 may have a generally planar or flat cooking surface 18a. Each grill 16, 18 further includes a plurality of drainage holes 30 adjacent the mid section of base 12. Drainage holes 30 are adapted to receive and drain food and cooking residue such as fat, oil etc., to remove the residue from the cooking surfaces. First and second grills 16, 18 may be sloped toward drainage holes 30 to facilitate run off of the residue. The cooking residue preferably drains into a removable trough 32 (FIG. 6) located beneath first and second grills 16, 18.

Release members 22 are adapted to releasably secure first and second grills 16, 18 relative to base 12. Various release members 22 are contemplated. With reference to FIGS. 6, 7A and 7B, in one arrangement, each release member 22 is operatively connected to release latch 34. Release latch 34 defines ledge 36 which engages peripheral edge 38 of first and second grills 16, 18 when in the locked position of release member 22 and the release latch 34 as best depicted in FIG. 7A, i.e., the peripheral edge 38 of the first or second grill 16, 18 may be captured between ledge 36 of release latch 32 and horizontal surface 40 within base 12. Release member 22 is adapted to move in the direction of directional arrow “k” from the locked position depicted in FIG. 7A to a release position depicted in FIG. 7B. In the release position, ledge 36 of release latch 34 clears peripheral edge 38 of first or second grills 16, 18 to permit the grill 16, 18 to be removed from base 12. In one embodiment, grills 16, 18 are biased in a vertical direction through spring elements 42 whereby upon movement of release member 22 and release latch 34 to the release position, the grills 16, 18 are displaced upwardly in the direction of arrow “m” by the spring elements 42 thereby facilitating removal of the respective grill 16, 18 from base 12. Release member 22 is normally biased toward the locked position by coil spring 44. Once individually released, grills 16, 18 may be cleaned.

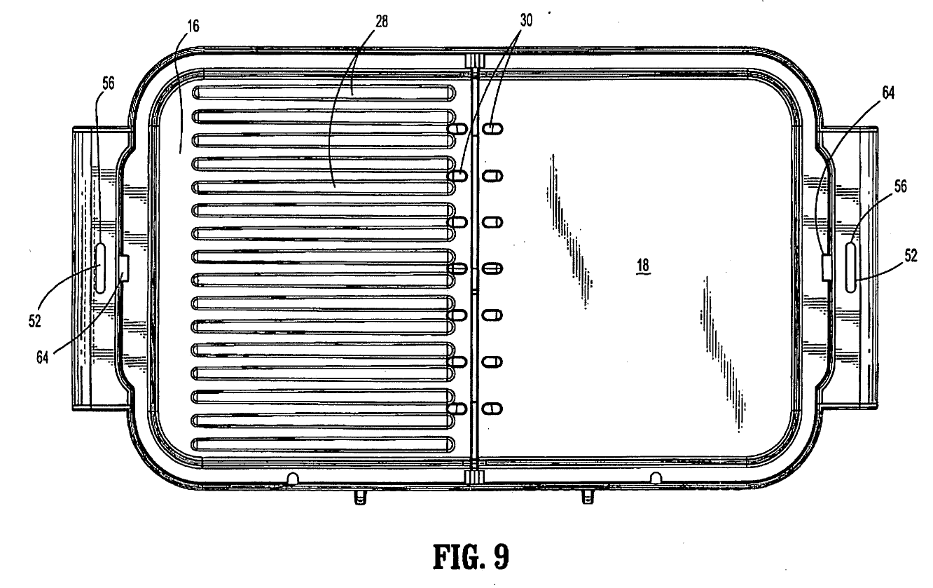

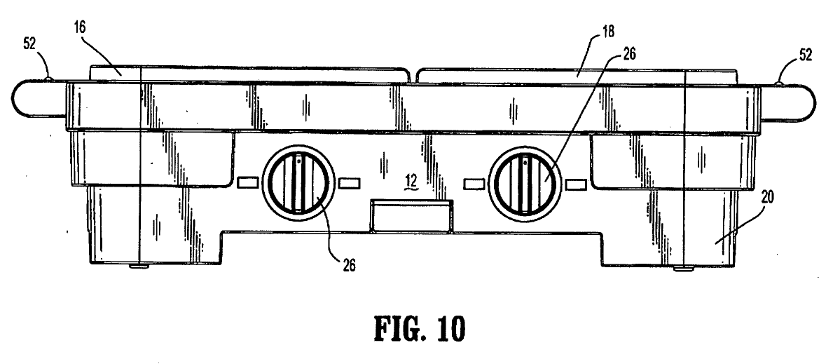

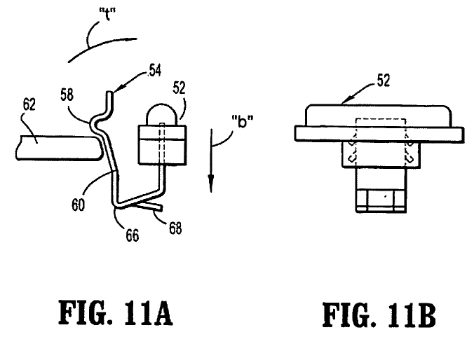

FIGS. 9, 10 and 11A-11B illustrate an alternate release member 50 for use with cooking apparatus 10. Release member 50 incorporates knob 52 having latch spring 54 depending from the knob 52. Release member 50 is positioned within slot 56 of each handle 14 whereby knob 52 extends from the slots 56. In the locked position of release member 50, arcuate locking portion 58 of spring leg 60 engages a peripheral edge 62 (shown schematically) of first or second grills 16, 18 to secure the grill 16, 18 to base 12. Arcuate locking portion may extend through recess 64 within the edge of first and second grills 16, 18 as shown in FIG. 9.To release first or second grills 16, 18, knob 52 is pressed downwardly in the direction of arrow “b” to cause spring leg 60 to pivot about fulcrum 66 in the direction of arrow “t” thereby displacing arcuate locking surface 58 from the edge 62 of the grills 16, 18 to permit removal of the respective grill 16, 18. Release member 50 is normally biased upwardly to the locked position by spring leg 68 which contacts a support surface of base 12.

Another release mechanism suitable for use with apparatus 10 is disclosed in commonly assigned U.S. Pat. No. 7,109,442 to Steinberg et al., the entire contents of which are incorporated herein by reference.

While the invention has been particularly shown, and described with reference to the preferred embodiments, it will be understood by those skilled in the art that various modifications and changes in form and detail may be made therein without departing from the scope and spirit of the invention. Accordingly, modifications such as those suggested above, but not limited thereto, are to be considered within the scope of the invention.

What is claimed is:

1. A grill apparatus, which comprises:
a base;
first and second grills supported by the base, each grill having a grilling surface for cooking a food product; and
first and second control members for independently and selectively controlling the temperature of the grilling surfaces of the first and second grills respectively.

2. The grill apparatus according to claim 1 including first and second heating elements supported by the base and in communication with the first and second grills respectively, the first and second heating elements being controlled the first and second control members respectively.

3. The grill apparatus according to claim 2 including a release mechanism for releasably securing at least one of the first and second grills to the base.

4. The grill apparatus according to claim 3 wherein the release mechanism includes a release member, the release member having a latch releasably engageable with the one of the first and second grills, the release member movable from a locked position whereby the latch engages the one of the first and second grills and a release position whereby the latch releases the one of the first and second grills to permit removal from the base.

5. The grill apparatus according to claim 4 wherein the release member is normally biased toward the locked position.

6. The grill apparatus according to claim 5 including first and second release mechanisms for releasably securing the first and second grills respectively to the base.

7. The grill apparatus according to claim 4 wherein the release member is slideably movable relative to the base to move between the locked position and the release position.

8. The grill apparatus according to claim 4 wherein the release member is adapted to pivot relative to the base between the locked position and the release position.

9. The grill apparatus according to claim 4 wherein the one of the first and second grills is normally biased in a direction away from the base whereby, upon release of the latch of the release member during movement thereof to the release position, the one of the first and second grills is displaced from the base, to thereby facilitate removal therefrom.

10. The grill apparatus according to claim 9 wherein the base houses a biasing spring, the biasing spring engaging and biasing the one of the first and second grills toward from the base.
